(19) United States
(12) Patent Application Publication
(10) Pub. No.: US 2021/0019562 A1
(43) Pub. Date: Jan. 21, 2021

(54) IMAGE PROCESSING METHOD AND APPARATUS AND STORAGE MEDIUM

(71) Applicant: Beijing Sensetime Technology Development Co., Ltd., Beijing (CN)

(72) Inventors: Kunlin YANG, Beijing (CN); Kun YAN, Beijing (CN); Jun HOU, Beijing (CN); Xiaocong CAI, Beijing (CN); Shual YI, Beijing (CN)

(21) Appl. No.: 17/002,114

(22) Filed: Aug. 25, 2020

Related U.S. Application Data
(63) Continuation of application No. PCT/CN2019/116612, filed on Nov. 8, 2019.

(30) Foreign Application Priority Data
Jul. 18, 2019 (CN) 201910652028.6

(51) Int. Cl. G06K 9/62; G06N 3/08

(52) U.S. Cl. CPC G06K 9/6251; G06N 3/08; G06K 9/629

(57) ABSTRACT

The present disclosure relates to an image processing method and device, an electronic apparatus and a storage medium, the method comprising: performing, by a feature extraction network, feature extraction on an image to be processed to obtain a first feature map of the image to be processed; performing, by an M-level encoding network, scale-down and multi-scale fusion processing on the first feature map to obtain a plurality of feature maps which are encoded, each of the plurality of feature maps having a different scale; and performing, by an N-level decoding network, scale-up and multi-scale fusion processing on the plurality of feature maps which are encoded to obtain a prediction result of the image to be processed. Embodiments of the present disclosure are capable of improving the quality and robustness of the prediction result.

The present application is a bypass continuation of and claims priority under 35 U.S.C. § 111(a) to PCT Application. No. PCT/CN2019/116612, filed on Nov. 8, 2019, which claims priority of Chinese Patent Application No. 201910652028.6, filed on Jul. 18, 2019 and entitled “Image processing method and device, electronic apparatus and storage medium”. The entire of these applications are incorporated herein by reference.

### TECHNICAL FIELD

The present disclosure relates to the technical field of computer, in particular to an image processing method and device, an electronic apparatus and a storage medium.

### BACKGROUND

As artificial intelligence technology is under uninterrupted growth, it achieves good effect in computer vision, speech recognition and other aspects. In a task of recognizing a target (e.g., pedestrian, vehicle, etc.) in a scenario, there may be a need to predict the amount and the distribution of targets in the scenario.

### SUMMARY

The present disclosure proposes a technical solution of an image processing.

According to an aspect of the present disclosure, there is provided an image processing method, comprising: performing, by a feature extraction network, feature extraction on an image to be processed, to obtain a first feature map of the image to be processed; performing, by an M-level encoding network, scale-down and multi-scale fusion processing on the first feature map to obtain a plurality of feature maps which are encoded, each of the plurality of feature maps having a different scale; and performing, by an N-level decoding network, scale-up and multi-scale fusion processing on a plurality of feature maps which are encoded to obtain a prediction result of the image to be processed, where M and N are integers greater than 1.

In a possible implementation, performing, by an M-level encoding network, scale-down and multi-scale fusion processing on the first feature map to obtain a plurality of feature maps which are encoded includes: performing, by a first-level encoding network, scale-down and multi-scale fusion processing on the first feature map to obtain a first feature map encoded at first level and a second feature map encoded at first level; performing, by an mth-level encoding network, scale-down and multi-scale fusion processing on m feature maps encoded at m−1th level to obtain m+1 feature maps encoded at mth level, where m is an integer and 1<m<M; and performing, by an Mth-level encoding network, scale-down and multi-scale fusion processing on M feature maps encoded at M−1th level to obtain M+1 feature maps encoded at Mth level.

In a possible implementation, performing, by a first-level encoding network, scale-down and multi-scale fusion processing on the first feature map to obtain a first feature map encoded at first level and a second feature map encoded at first level includes: performing scale-down on the first feature map to obtain a second feature map; and performing fusion on the first feature map and the second feature map to obtain a first feature map encoded at first level and a second feature map encoded at first level.

In a possible implementation, performing, by an mth-level encoding network, scale-down and multi-scale fusion processing on m feature maps encoded at m−1th level to obtain m+1 feature maps encoded at mth level includes: performing scale-down and fusion on m feature maps encoded at m−1th level to obtain an m+1th feature map, the m+1th feature map having a scale smaller than a scale of the m feature maps encoded at m−1th level; and performing fusion on the m feature maps encoded at m−1th level and the m+1th feature map to obtain m+1 feature maps encoded at mth level.

In a possible implementation, performing scale-down and fusion on m feature maps encoded at m−1th level to obtain an m+1th feature map includes: performing, by a convolution sub-network of an mth-level encoding network, scale-down on m feature maps encoded at m−1th level, respectively, to obtain m feature maps subjected to scale-down, the m feature maps subjected to scale-down having a scale equal to a scale of the m+1th feature map; and performing feature fusion on the m feature maps subjected to scale-down to obtain the m+1th feature map.

In a possible implementation, performing fusion on m feature maps encoded at m−1th level and the m+1th feature map to obtain m+1 feature maps encoded at mth level includes: performing, by a feature optimizing sub-network of an mth-level encoding network, feature optimization on m feature maps encoded at m−1th level and the m+1th feature map, respectively, to obtain m+1 feature maps subjected to feature optimization; and performing, by m+1 fusion sub-networks of an mth-level encoding network, fusion on the m+1 feature maps subjected to feature optimization, respectively, to obtain m+1 feature maps encoded at mth level.

In a possible implementation, the convolution sub-network includes at least one first convolution layer, the first convolution layer having a convolution kernel size of 3×3 and a step length of 2; the feature optimizing sub-network includes at least two second convolution layers and residual layers, the second convolution layer having a convolution kernel size of 3×3 and a step length of 1; the m+1 fusion sub-networks are corresponding to m+1 feature maps subjected to optimization.

In a possible implementation, for a kth fusion sub-network of m+1 fusion sub-networks, performing, by m+1 fusion sub-networks of an mth-level encoding network, fusion on the m+1 feature maps subjected to feature optimization, respectively, to obtain m+1 feature maps encoded at mth level includes: performing, by at least one first convolution layer, scale-down on k−1 feature maps having a scale greater than that of a kth feature map subjected to feature optimization to obtain k−1 feature maps subjected to scale-down, the k−1 feature maps subjected to scale-down having a scale equal to a scale of the kth feature map subjected to feature optimization; and/or performing, by an upsampling layer and a third convolution layer, scale-up and channel adjustment on m+1−k feature maps having a scale smaller than that of the kth feature map subjected to feature optimization to obtain m+1−k feature maps subjected to scale-up, the m+1−k feature maps subjected to scale-up having a scale equal to a scale of the kth feature map subjected to feature optimization; wherein, k is an integer and 1≤k≤m+1, the third convolution layer having a convolution kernel size of 1×1.

In a possible implementation, performing, by m+1 fusion sub-networks of an mth-level encoding network, fusion on the m+1 feature maps subjected to feature optimization, respectively, to obtain m+1 feature maps encoded at mth level further includes: performing fusion on at least two of the k−1 feature maps subjected to scale-down, the kth feature map subjected to feature optimization and the m+1−k feature maps subjected to scale-up, to obtain a kth feature map encoded at mth level.

In a possible implementation, performing, by an N-level decoding network, scale-up and multi-scale fusion processing on a plurality of feature maps which are encoded to obtain a prediction result of the image to be processed includes: performing, by a first-level decoding network, scale-up and multi-scale fusion processing on M+1 feature maps encoded at Mth level to obtain M feature maps decoded at first level; performing, by an nth-level decoding network, scale-up and multi-scale fusion processing on the M−n+2 feature maps decoded at n−1th level to obtain M−n+1 feature maps decoded at nth level, n being an integer and 1<n<N≤M; and performing, by an Nth-level decoding network, multi-scale fusion processing on the M−N+2 feature maps decoded at N−1th level to obtain a prediction result of the image to be processed.

In a possible implementation, performing, by an nth-level decoding network, scale-up and multi-scale fusion processing on M−n+2 feature maps decoded at n−1th level to obtain M−n+1 feature maps decoded at nth level includes: performing fusion and scale-up on the M−n+2 feature maps decoded at n−1th level to obtain M−n+1 feature maps subjected to scale-up; and performing fusion on the M−n+1 feature maps subjected to scale-up to obtain M−n+1 feature maps decoded at nth level.

In a possible implementation, performing, by an Nth-level decoding network, multi-scale fusion processing on M−N+2 feature maps decoded at N−1th level to obtain a prediction result of the image to be processed includes: performing multi-scale fusion on the M−N+2 feature maps decoded at N−1th level to obtain a target feature map decoded at Nth level; and determining a prediction result of the image to be processed according to the target feature map decoded at Nth level.

In a possible implementation, performing fusion and scale-up on M−n+2 feature maps decoded at n−1th level to obtain M−n+1 feature maps subjected to scale-up includes: performing, by M−n+1 first fusion sub-networks of an nth-level decoding network, fusion on M−n+2 feature maps decoded at n−1th level to obtain M−n+1 feature maps subjected to fusion; and performing, by a deconvolution sub-network of an nth-level decoding network, scale-up on the M−n+1 feature maps subjected to fusion, respectively, to obtain M−n+1 feature maps subjected to scale-up.

In a possible implementation, performing fusion on the M−n+1 feature maps subjected to scale-up to obtain M−n+1 feature maps decoded at nth level includes: performing, by M−n+1 second fusion sub-networks of an nth decoding network, fusion on the M−n+1 feature maps subjected to scale-up to obtain M−n+1 feature maps subjected to fusion; and performing, by a feature optimizing sub-network of an nth-level decoding network, optimization on the M−n+1 feature maps subjected to fusion, respectively, to obtain M−n+1 feature maps decoded at nth level.

In a possible implementation, determining a prediction result of the image to be processed according to the target feature map decoded at Nth level includes: performing optimization on the target feature map decoded at Nth level to obtain a predicted density map of the image to be processed; and determining a prediction result of the image to be processed according to the predicted density map.

In a possible implementation, performing, by a feature extraction network, feature extraction on an image to be processed, to obtain a first feature map of the image to be processed includes: performing, by at least one first convolution layer of the feature extraction network, convolution on the image to be processed to obtain a feature map subjected to convolution; and performing, by at least one second convolution layer of the feature extraction network, optimization on the feature map subjected to convolution to obtain a first feature map of the image to be processed.

In a possible implementation, the first convolution layer has a convolution kernel size of 3×3 and a step length of 2; the second convolution layer has a convolution kernel size of 3×3 and a step length of 1.

In a possible implementation, the method further comprises: training the feature extraction network, the M-level encoding network and the N-level decoding network according to a preset training set, the training set containing a plurality of sample images which have been labeled.

According to an aspect of the present disclosure, there is provided an image processing device, comprising: a feature extraction module configured to perform, by a feature extraction network, feature extraction on an image to be processed, to obtain a first feature map of the image to be processed; an encoding module configured to perform, by an M-level encoding network, scale-down and multi-scale fusion processing on the first feature map to obtain a plurality of feature maps which are encoded, each of the plurality of feature maps having a different scale; and a decoding module configured to perform, by an N-level decoding network, scale-up and multi-scale fusion processing on a plurality of feature maps which are encoded to obtain a prediction result of the image to be processed, M, N being integers greater than 1.

In a possible implementation, the encoding module comprises: a first encoding sub-module configured to perform, by a first-level encoding network, scale-down and multi-scale fusion processing on the first feature map to obtain a first feature map encoded at first level and a second feature map encoded at first level; a second encoding sub-module configured to perform, by an mth-level encoding network, scale-down and multi-scale fusion processing on m feature maps encoded at m−1th level to obtain m+1 feature maps encoded at mth level, where m is an integer and 1<m<M; and a third encoding sub-module configured to perform, by an Mth-level encoding network, scale-down and multi-scale fusion processing on M feature maps encoded at M−1th level to obtain M+1 feature maps encoded at Mth level.

In a possible implementation, the first encoding sub-module comprises: a first scale-down sub-module configured to perform scale-down on the first feature map to obtain a second feature map; and a first fusion sub-module configured to perform fusion on the first feature map and the second feature map to obtain a first feature map encoded at first level and a second feature map encoded at first level.

In a possible implementation, the second encoding sub-module comprises: a second scale-down sub-module configured to perform scale-down and fusion on m feature maps encoded at m−1th level to obtain an m+1th feature map, the m+1th feature map having a scale smaller than a scale of the m feature maps encoded at m-th level; and a second fusion sub-module configured to perform fusion on the m feature maps encoded at m−1th level and the m+1th feature map to obtain m+1 feature maps encoded at mth level.

In a possible implementation, the second reduction sub-module is configured to perform, by a convolution sub-network of an mth-level encoding network, scale-down on m feature maps encoded at m−1th level, respectively, to obtain m feature maps subjected to scale-down, the m feature maps subjected to scale-down having a scale equal to a scale of the m+1th feature map; and to perform feature fusion on the m feature maps subjected to scale-down to obtain the m+1th feature map.

In a possible implementation, the second fusion sub-module is configured to perform, by a feature optimizing sub-network of an mth-level encoding network, feature optimization on m feature maps encoded at m−1th level and the m+1th feature map, respectively, to obtain m+1 feature maps subjected to feature optimization, and to perform, by m+1 fusion sub-networks of an mth-level encoding network, fusion on the m+1 feature maps subjected to feature optimization, respectively, to obtain m+1 feature maps encoded at mth level.

In a possible implementation, the convolution sub-network includes at least one first convolution layer, the first convolution layer having a convolution kernel size of 3×3 and a step length of 2; the feature optimizing sub-network includes at least two second convolution layers and residual layers, the second convolution layer having a convolution kernel size of 3×3 and a step length of 1; the m+1 fusion sub-networks are corresponding to m+1 feature maps subjected to optimization.

In a possible implementation, for a kth fusion sub-network of m+1 fusion sub-networks, performing, by m+1 fusion sub-networks of an mth-level encoding network, fusion on the m+1 feature maps subjected to feature optimization, respectively, to obtain m+1 feature maps encoded at mth level includes: performing, by at least one first convolution layer, scale-down on k−1 feature maps having a scale greater than that of a kth feature map subjected to feature optimization to obtain k−1 feature maps subjected to scale-down, the k−1 feature maps subjected to scale-down having a scale equal to a scale of a kth feature map subjected to feature optimization; and/or performing, by an upsampling layer and a third convolution layer, scale-up and channel adjustment on m+1−k feature maps having a scale smaller than that of a kth feature map subjected to feature optimization to obtain m+1−k feature maps subjected to scale-up, the m+1−k feature maps subjected to scale-up having a scale equal to a scale of a kth feature map subjected to feature optimization; wherein, k is an integer and 1≤k≤m+1, the third convolution layer has a convolution kernel size of 1×1.

In a possible implementation, performing, by m+1 fusion sub-networks of an mth-level encoding network, fusion on the m+1 feature maps subjected to feature optimization, respectively, to obtain m+1 feature maps encoded at mth level further includes: performing fusion on at least two of the k−1 feature maps subjected to scale-down, the kth feature map subjected to feature optimization and the m+1−k feature maps subjected to scale-up, to obtain a kth feature map encoded at mth level.

In a possible implementation, the decoding module comprises: a first decoding sub-module configured to perform, by a first-level decoding network, scale-up and multi-scale fusion processing on M+1 feature maps encoded at Mth level to obtain M feature maps decoded at first level; a second decoding sub-module configured to perform, by an nth-level decoding network, scale-up and multi-scale fusion processing on M−n+2 feature maps decoded at n−1th level to obtain M−n+1 feature maps decoded at nth level, n being an integer and 1<n<N SM; and a third decoding sub-module configured to perform, by an Nth-level decoding network, multi-scale fusion processing on M−N+2 feature maps decoded at N−1th level to obtain a prediction result of the image to be processed.

In a possible implementation, the second decoding sub-module comprises: a scale-up sub-module configured to perform fusion and scale-up on M−n+2 feature maps decoded at n−1th level to obtain M−n+1 feature maps subjected to scale-up; and a third fusion sub-module configured to perform fusion on the M−n+1 feature maps subjected to scale-up to obtain M−n+1 feature maps decoded at nth level.

In a possible implementation, the third decoding sub-module comprises: a fourth fusion sub-module configured to perform multi-scale fusion on M−N+2 feature maps decoded at N−1th level to obtain a target feature map decoded at Nth level; and a result determination sub-module configured to determine a prediction result of the image to be processed according to the target feature map decoded at Nth level.

In a possible implementation, the scale-up sub-module is configured to perform, by M−n+1 first fusion sub-networks of an nth-level decoding network, fusion on M−n+2 feature maps decoded at n−1th level to obtain M−n+1 feature maps subjected to fusion; and to perform, by a deconvolution sub-network of an nth-level decoding network, scale-up on M−n+1 feature maps subjected to fusion, respectively, to obtain M−n+1 feature maps subjected to scale-up.

In a possible implementation, the third fusion sub-module is configured to perform, by M−n+1 second fusion sub-networks of an nth-level decoding network, fusion on the M−n+1 feature maps subjected to scale-up to obtain M−n+1 feature maps subjected to fusion; and to perform, by a feature optimizing sub-network of an nth-level decoding network, optimization on the M−n+1 feature maps subjected to fusion, respectively, to obtain M−n+1 feature maps decoded at nth level.

In a possible implementation, the result determination sub-module is configured to perform optimization on the target feature map decoded at Nth level to obtain a predicted density map of the image to be processed; and to determine a prediction result of the image to be processed according to the predicted density map.

In a possible implementation, the feature extraction module comprises: a convolution sub-module configured to perform, by at least one first convolution layer of the feature extraction network, convolution on the image to be processed to obtain a feature map subjected to convolution; and an optimization sub-module configured to perform, by at least one second convolution layer of the feature extraction network, optimization on a feature map subjected to convolution to obtain a first feature map of the image to be processed.

In a possible implementation, the first convolution layer has a convolution kernel size of 3×3 and a step length of 2; the second convolution layer has a convolution kernel size of 3×3 and a step length of 1.

In a possible implementation, the device further comprises: a training sub-module configured to train the feature extraction network, the M-level encoding network and the N-level decoding network according to a preset training set, the training set containing a plurality of sample images which have been labeled.

According to another aspect of the present disclosure, there is provided an electronic apparatus, comprising: a processor, and a memory configured to store instructions executable by the processor, wherein the processor is configured to invoke the instructions stored in the memory to execute the afore-described method.

According to another aspect of the present disclosure, there is provided a computer readable storage medium having computer program instructions stored thereon, the computer program instructions implementing the afore-described method when being executed by a processor.

According to another aspect of the present disclosure, there is provided a computer program, the computer program including computer readable codes, when the computer readable codes run in an electronic apparatus, a processor of the electronic apparatus executes the afore-described method.

In the embodiments of the present disclosure, it is possible to perform scale-down and multi-scale fusion on feature maps of an image by an M-level encoding network and perform scale-up and multi-scale fusion on a plurality of encoded feature maps by an N-level decoding network, so as to perform multiple times of fusion of global information and local information at multiple scales during encoding and decoding processes, thereby maintaining more effective multi-scale information, and improving the quality and robustness of a prediction result.

It is appreciated that the foregoing general description and the subsequent detailed description are exemplary and illustrative, and does not limit the present disclosure. According to the subsequent detailed description of exemplary embodiments with reference to the attached drawings, other features and aspects of the present disclosure will become clear.

### BRIEF DESCRIPTION OF THE DRAWINGS

The drawings here are incorporated in and constitute part of the specification, these drawings show embodiments according to the present disclosure, and together with the description, illustrate the technical solution of the present disclosure.

FIG. 1 shows a flow chart of the image processing method according to an embodiment of the present disclosure.

FIGS. 2a, 2b and 2c show schematic diagrams of the multi-scale fusion process of an image processing method according to an embodiment of the present disclosure.

FIG. 3 shows a schematic diagram of the network configuration of the image processing method according to an embodiment of the present disclosure.

FIG. 4 shows a frame chart of the image processing device according to an embodiment of the present disclosure.

FIG. 5 shows a frame chart of the electronic apparatus according to an embodiment of the present disclosure.

FIG. 6 shows a frame chart of the electronic apparatus according to an embodiment of the present disclosure.

### DETAILED DESCRIPTION

Various exemplary embodiments, features and aspects of the present disclosure will be described in detail with reference to the drawings. The same reference numerals in the drawings represent elements having the same or similar functions. Although various aspects of the embodiments are shown in the drawings, it is unnecessary to proportionally draw the drawings unless otherwise specified.

Herein the specific term “exemplary” means “used as an instance or embodiment, or explanatory”. Any “exemplary” embodiment given here is not necessarily construed as being superior to or better than other embodiments.

Herein the term “and/or” only describes an association relation between associated objects and indicates three possible relations. For example, the phrase “A and/or B” may indicate three cases which are a case where only A is present, a case where A and B are both present, and a case where only B is present. In addition, the term “at least one” herein indicates any one of a plurality or an arbitrary combination of at least two of a plurality. For example, including at least one of A, B and C may mean including any one or more elements selected from a set consisting of A, B and C.

In addition, numerous specific details are given in the following specific embodiments for the purpose of better explaining the present disclosure. It should be understood by a person skilled in the art that the present disclosure can still be implemented even without some of those specific details. In some of the instances, methods, means, units and circuits that are well known to a person skilled in the art are not described in detail so that the principle of the present disclosure become apparent.

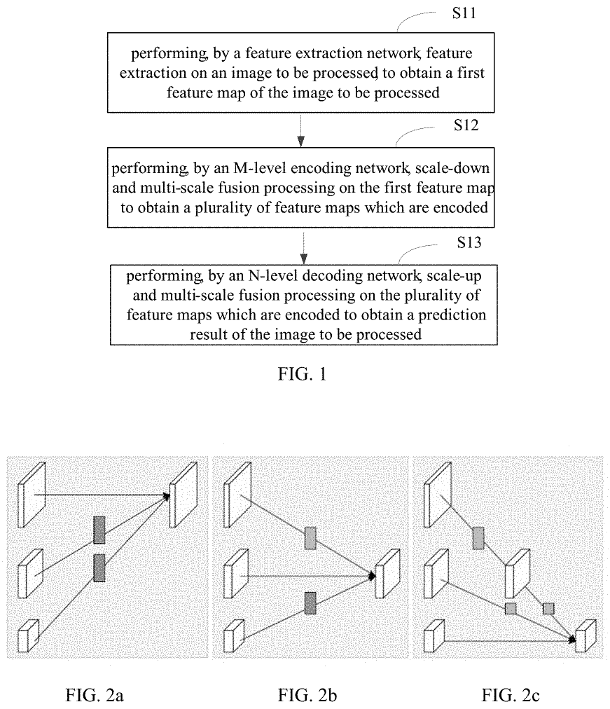

FIG. 1 shows a flow chart of the image processing method according to an embodiment of the present disclosure. As shown in FIG. 1, the image processing method comprises:

a step S1 of performing, by a feature extraction network, feature extraction on an image to be processed, to obtain a first feature map of the image to be processed;

a step S12 of performing, by an M-level encoding network, scale-down and multi-scale fusion processing on the first feature map to obtain a plurality of feature maps which are encoded, each of the plurality of feature maps having a different scale;

a step S13 of performing, by an N-level decoding network, scale-up and multi-scale fusion processing on the plurality of feature maps which are encoded to obtain a prediction result of the image to be processed, M, N being integers greater than 1.

In a possible implementation, the image processing method may be executed by an electronic apparatus such as terminal equipment or server. The terminal equipment may be User Equipment (UE), mobile apparatus, user terminal, terminal, cellular phone, cordless phone, Personal Digital Assistant (PDA), handheld apparatus, computing apparatus, on-board equipment, wearable apparatus, etc. The method may be implemented by a processor invoking computer readable instructions stored in a memory. Alternatively, the method may be executed by a server.

In a possible implementation, the image to be processed may be an image of a monitored area (e.g., cross road, shopping mall, etc.) captured by an image pickup apparatus (e.g., a camera) or an image obtained by other methods (e.g., an image downloaded from the Internet). The image to be processed may contain a certain amount of targets (pedestrians, vehicles, customers, etc.). The present disclosure does not limit the type and the acquisition method of the image to be processed or the type of the targets in the image.

In a possible implementation, the image to be processed may be analyzed by a neural network (e.g., including a feature extraction network, an encoding network and a decoding network) to predict information such as the amount and the distribution of targets in the image to be processed. The neural network may, for example, include a convolution neural network. The present disclosure does not limit the specific type of the neural network.

In a possible implementation, feature extraction may be performed in the step S11 on the image to be processed by a feature extraction network to obtain a first feature map of the image to be processed. The feature extraction network may at least include convolution layers, may reduce the scale of image or feature map by a convolution layer having a step length (step length>1), and may perform optimization on feature maps by a convolution layer having no step length (step length=1). After the processing by the feature extraction network, the first feature map is obtained. The present disclosure does not limit the network structure of the feature extraction network.

Since a feature map having a relatively large scale includes more local information of the image to be processed and a feature map having a relatively small scale includes more global information of the image to be processed, the global and local information may be fused at multiple scales to extract more effective multi-scale features.

In a possible implementation, scale-down and multi-scale fusion processing may be performed in the step S12 on the first feature map by an M-level encoding network to obtain a plurality of feature maps which are encoded. Each of the plurality of feature maps has a different scale. Thus, the global and local information may be fused at each scale to improve the validity of the extracted features.

In a possible implementation, the encoding networks at each level in the M-level encoding network may include convolution layers, residual layers, upsampling layers, fusion layers, and so on. Regarding the first-level encoding network, scale-down may be performed by the convolution layer (step length >1) of the first-level encoding network on the first feature map to obtain a feature map subjected to scale-down (second feature map); feature optimization may be performed by the convolution layer (step length=1) and/or residual layer of the first-level encoding network on the first feature map and the second feature map to obtain the first feature map subjected to feature optimization and the second feature map subjected to feature optimization; thence, fusion are performed by the upsampling layer, the convolution layer (step length >1) and/or the fusion layer of the first-level encoding network on the first feature map subjected to feature optimization and the second feature map subjected to feature optimization, respectively, to obtain a first feature map encoded at first level and a second feature map encoded at first level.

In a possible implementation, similar to the first-level encoding network, scale-down and multi-scale fusion may be performed by the encoding networks at each level in the M-level encoding network may perform on multiple feature maps encoded at a prior level in turn, so as to further improve the validity of the extracted features by multiple times of fusion of global and local information.

In a possible implementation, after the processing by the M-level encoding network, a plurality of M-level encoded feature maps are obtained. In the step S13, scale-up and multi-scale fusion processing are performed on the plurality of encoded feature maps by N-level decoding network to obtain N-level decoded feature maps of the image to be processed, thereby obtaining a prediction result of the image to be processed.

In a possible implementation, the decoding network of each level in the N-level decoding network may include fusion layers, deconvolution layers, convolution layers, residual layers, upsampling layers, etc. Regarding the first-level decoding network, fusion may be performed by the fusion layer of the first-level decoding network on the plurality of encoded feature maps to obtain a plurality of feature maps subjected to fusion; then, scale-up is performed on the plurality of feature maps subjected to fusion by the deconvolution layer to obtain a plurality of feature maps subjected to scale-up; fusion and optimization are performed on the plurality of feature maps by the fusion layers, the convolution layers (step length=1) and/or the residual layers, etc., respectively, to obtain a plurality of feature maps decoded at first level.

In a possible implementation, similar to the first-level decoding network, scale-up and multi-scale fusion may be performed by the decoding network of each level in the N-level decoding network on feature maps decoded at a prior level in turn. The amount of feature maps obtained by the decoding network of each level reduces in turn. After the Nth-level decoding network, a density map (e.g., a distribution density map of a target) having a scale consistent with the image to be processed is obtained, thereby determining the prediction result. Thus, quality of the prediction result is improved by fusing global and local information for multiple times during the process of scale-up.

According to the embodiments of the present disclosure, it is possible to perform scale-down and multi-scale fusion on the feature maps of an image by the M-level encoding network and to perform scale-up and multi-scale fusion on a plurality of encoded feature maps by the N-level decoding network, thereby fusing global and local information for multiple times during the encoding and decoding process. Accordingly, more effective multi-scale information is remained, and the quality and the robustness of the prediction result is improved.

In a possible implementation, the step S11 may include:

performing, by at least one first convolution layer of the feature extraction network, convolution on the image to be processed to obtain a feature map subjected to convolution; and

performing, by at least one second convolution layer of the feature extraction network, optimization on the feature map subjected to convolution to obtain a first feature map of the image to be processed.

For example, the feature extraction network may include at least one first convolution layer and at least one second convolution layer. The first convolution layer is a convolution layer having a step length (step length >1) which is configured to reduce the scale of images or feature maps. The second convolution layer is a convolution layer having no step length (step length=1) which is configured to optimize feature maps.

In a possible implementation, the feature extraction network may include two continuous first convolution layers, the first convolution layer having a convolution kernel size of 3×3 and a step length of 2. After the image to be processed is subjected to convolution by two continuous first convolution layers, a feature map subjected to convolution is obtained. The width and the height of the feature map are ¼ the width and the height of the image to be processed, respectively. It should be understood that a person skilled in the art may set the amount, the size of the convolution kernel and the step length of the first convolution layer according to the actual situation. The present disclosure does not limit these.

In a possible implementation, feature extraction network may include three continuous second convolution layers, the second convolution layer having a convolution kernel size of 3×3 and a step length of 1. After the feature map subjected to convolution by the first convolution layers is subjected to optimization by three continuous first convolution layers, a first feature map of the image to be processed is obtained. The first feature map has a scale identical to the scale of the feature map subjected to convolution by the first convolution layers.

In other words, the width and the height of the first feature map are ¼ the width and the height of the image to be processed, respectively. It should be understood that a person skilled in the art may set the amount and the size of the convolution kernel of the second convolution layers according to the actual situation. The present disclosure does not limit these.

In such manner, it is possible to realize scale-down and optimization of the image to be processed and effectively extract feature information.

In a possible implementation, the step S12 may include:

performing, by a first-level encoding network, scale-down and multi-scale fusion processing on the first feature map to obtain a first feature map encoded at first level and a second feature map encoded at first level;

performing, by an mth-level encoding network, scale-down and multi-scale fusion processing on m feature maps encoded at m−1th level to obtain m+1 feature maps encoded at mth level, where m is an integer and 1<m<M; and

performing, by an Mth-level encoding network, scale-down and multi-scale fusion processing on M feature maps encoded at M−1th level to obtain M+1 feature maps encoded at Mth level.

For example, processing may be performed in turn by the encoding network of each level in the M-level encoding network on a feature map encoded at a prior level. The encoding network of each level may include convolution layers, residual layers, upsampling layers, fusion layers, and the like. Regarding the first-level encoding network, scale-down and multi-scale fusion processing may be performed by the first-level encoding network on the first feature map to obtain a first feature map encoded at first level and a second feature map encoded at first level.

In a possible implementation, the step of performing, by a first-level encoding network, scale-down and multi-scale fusion processing on the first feature map to obtain a first feature map encoded at first level and a second feature map encoded at first level may include: performing scale-down on the first feature map to obtain a second feature map; and performing fusion on the first feature map and the second feature map to obtain a first feature map encoded at first level and a second feature map encoded at first level.

For example, scale-down may be performed by the first convolution layer (convolution kernel size is 3×3, and step length is 2) of the first-level encoding network on the first feature map to obtain the second feature map having a scale smaller than that of the first feature map; the first feature map and the second feature map are optimized by the second convolution layer (convolution kernel size is 3×3, and step length is 1) and/or the residual layers, respectively, to obtain optimized first feature map and optimized second feature map; and perform multi-scale fusion on the first feature map and the second feature map by the fusion layers, respectively, to obtain a first feature map encoded at first level and a second feature map encoded at first level.

In a possible implementation, optimization of the feature maps may be directly performed by the second convolution layer; alternatively, the optimization of the feature maps may be performed by basic blocks formed by second convolution layers and residual layers. The basic blocks may serve as the basic unit of optimization. Each basic block may include two continuous second convolution layers. Thence, the input feature map and the feature map obtained by convolution are summed up and output as a result by the residual layers. The present disclosure does not limit the specific optimization method.

In a possible implementation, the first feature map and the second feature map subjected to multi-scale fusion may be optimized and fused again. The first feature map and the second feature map which are optimized and fused again serve as the first feature map and the second feature map encoded at first level, so as to further improve the validity of extracted multi-scale features. The present disclosure does not limit the number of times of optimization and multi-scale fusion.

In a possible implementation, for the encoding network of any level in the M-level encoding network (the mth-level encoding network, m being an integer and 1<m<M), scale-down and multi-scale fusion processing may be performed by the mth-level encoding network on m feature maps encoded at m−1th level to obtain m+1 feature maps encoded at mth level.

In a possible implementation, the step of performing, by the mth-level encoding network, scale-down and multi-scale fusion on m feature maps encoded at m−1th level to obtain m+1 feature maps encoded at mth level may include: performing scale-down and fusion on m feature maps encoded at m−1th level to obtain an m+1th feature map, the m+1th feature map having a scale smaller than a scale of the m feature maps encoded at m−1th level; and performing fusion on m feature maps encoded at m−1th level and the m+1th feature map to obtain m+1 feature maps encoded at mth level.

In a possible implementation, the step of performing scale-down and fusion on m feature maps encoded at m−1th level to obtain an m+1th feature map may include: performing, by a convolution sub-network of an mth-level encoding network, scale-down on m feature maps encoded at m−1th level, respectively, to obtain m feature maps subjected to scale-down, the m feature maps subjected to scale-down having a scale equal to a scale of the m+1th feature map; and performing feature fusion on the m feature maps subjected to scale-down to obtain the m+1th feature map.

For example, scale-down may be performed by m convolution sub-networks of the mth encoding network (each convolution sub-network including at least one first convolution layer) on m feature maps encoded at m−1th level, respectively, to obtain m feature maps subjected to scale-down. The m feature maps subjected to scale-down have the same scale smaller than that of the mth feature map encoded at m−1th level (i.e., equal to the scale of the m+1th feature map). Feature fusion is performed by the fusion layer on the m feature maps subjected to scale down to obtain the m+1th feature map.

In a possible implementation, each convolution sub-network includes at least one first convolution layer configured to perform scale-down on feature maps, the first convolution layer having a convolution kernel size of 3×3 and a step length of 2. The amount of first convolution layers of the convolution sub-network is associated with the scale of the corresponding feature maps. For example, in an event that the scale of the first feature map encoded at m−1 level is 4× (width and height being ¼ of that of the image to be processed) and the scale of the m feature maps to be generated is 16× (width and height being 1/16 of that of the image to be processed), the first convolution sub-network includes two first convolution layers. It should be understood that a person skilled in the art may set the amount of the first convolution layer, the size of the convolution kernel and the step length of the convolution sub-network according to the actual situation. The present disclosure does not limit these.

In a possible implementation, the step of fusing the m feature maps encoded at m−1th level and the m+1th feature map to obtain m+1 feature maps encoded at mth level may include: performing, by a feature optimizing sub-network of an mth-level encoding network, feature optimization on m feature maps encoded at m−1th level and the m+1th feature map, respectively, to obtain m+1 feature maps subjected to feature optimization; and performing, by m+1 fusion sub-networks of an mth-level encoding network, fusion on the m+1 feature maps subjected to feature optimization, respectively, to obtain m+1 feature maps encoded at mth level.

In a possible implementation, multi-scale fusion may be performed by the fusion layers on m feature maps encoded at m−1th level to obtain m feature maps subjected to fusion; feature optimization may be performed by m+1 feature optimizing sub-networks (each feature optimizing sub-network comprising second convolution layers and/or residual layers) on the m feature maps subjected to fusion and the m+1th feature map, respectively, to obtain m+1 feature maps subjected to feature optimization; then, multi-scale fusion is performed by m+1 fusion sub-networks on the m+1 feature maps subjected to feature optimization, respectively, to obtain m+1 feature maps encoded at mth level.

In a possible implementation, the m feature maps encoded at m−1th level may be directly processed by m+1 feature optimizing sub-networks (each feature optimizing sub-network comprising second convolution layers and/or residual layers). In other words, feature optimization is performed by m+1 feature optimizing sub-networks on the m feature maps encoded at m−1th level and the m+1th feature maps, respectively, to obtain m+1 feature maps subjected to feature optimization; then, multi-scale fusion is performed on the m+1 feature maps subjected to feature optimization by m+1 fusion sub-networks, respectively, to obtain m+1 feature maps encoded at mth level.

In a possible implementation, feature optimization and multi-scale fusion may be performed again on the m+1 feature maps subjected to multi-scale fusion, so as to further improve the validity of the extracted multi-scale features. The present disclosure does not limit the number of times of feature optimization and multi-scale fusion.

In a possible implementation, each feature optimizing sub-network may include at least two convolution layers and residual layers. The second convolution layer has a convolution kernel size of 3×3 and a step length of 1. For example, each feature optimizing sub-network may include at least one basic block (two continuous second convolution layers and residual layers). Feature optimization may be performed by the basic block of each feature optimizing sub-network on the m feature maps encoded at m−1th level and the m+1th feature map, respectively, to obtain m+1 feature maps subjected to feature optimization. It should be understood that those skilled in the art may set the amount of the second convolution layer and the convolution kernel size according to the actual situation, which is not limited by the present disclosure.

In such manner, it is possible to further improve the validity of the extracted multi-scale features.

In a possible implementation, the m+1 fusion sub-networks of a mth level encoding network may respectively perform fusion on the m+1 feature maps subjected to feature optimization, respectively. For a kth fusion sub-network (k is an integer and 1≤k≤m+1) of m+1 fusion sub-networks, performing, by m+1 fusion sub-networks of an mth-level encoding network, fusion on the m+1 feature maps subjected to feature optimization, respectively, to obtain m+1 feature maps encoded at mth level includes:

performing, by at least one first convolution layer, scale-down on k−1 feature maps having a scale greater than that of the kth feature map subjected to feature optimization to obtain k−1 feature maps subjected to scale-down, the k−1 feature maps subjected to scale-down having a scale equal to a scale of a kth feature map subjected to feature optimization; and/or

performing, by an upsampling layer and a third convolution layer, scale-up and channel adjustment on m+1−k feature maps having a scale smaller than that of the kth feature map subjected to feature optimization to obtain m+1−k feature maps subjected to scale-up, the m+1−k feature maps subjected to scale-up having a scale equal to the scale of the kth feature map subjected to feature optimization, the third convolution layer having a convolution kernel size of 1×1.

For example, the kth fusion sub-network may first adjust the scale of the m+1 feature maps into the scale of the kth feature map subjected to feature optimization. In a case where 1<k<m+1, k−1 feature maps before the kth feature map subjected to feature optimization each have a scale greater than that of the kth feature map subjected to feature optimization. For example, the kth feature map has a scale of 16× (width and height being 1/16 the width and the height of the image to be processed); and the feature maps before the kth feature map have a scale of 4× and 8×. In such case, scale-down may be performed on a k−1th feature map having a scale greater than that of a kth feature map subjected to feature optimization by at least one first convolution layer to obtain k−1 feature maps subjected to scale-down. That is, the feature maps having a scale of 4× and 8× are all scaled down to feature maps of 16×. The scale-down may be performed on feature maps of 4× by two first convolution layers; and the scale-down may be performed on feature maps of 8× by a first convolution layer. Thus, k−1 feature maps subjected to scale-down are obtained.

In a possible implementation, in a case where 1<k<m+1, the scales of m+1−k feature maps after the kth feature map subjected to feature optimization are all smaller than that of the kth feature map subjected to feature optimization. For example, the kth feature map has a scale of 16× (width and height being 1/16 the width and the height of the image to be processed); the m+1−k feature maps after the kth feature map have a scale of 32×. In such case, scale-up may be performed on the feature maps of 32× by the upsampling layers; and channel adjustment is performed by the third convolution layer (convolution kernel size 1×1) on the feature map subjected to scale-up so that the feature map subjected to scale-up has the same amount of channels with the kth feature map, thereby obtaining a feature map having a scale of 16×. Thus, m+1−k feature maps subjected to scale-up are obtained.

In a possible implementation, in a case where k=1, m feature maps after the first feature map subjected to feature optimization all have a scale smaller than that of the first feature map subjected to feature optimization. Hence, the subsequent m feature maps may be all subjected to scale-up and channel adjustment to obtain subsequent m feature maps subjected to scale-up. In a case where k=m+1, m feature maps preceding the m+1th feature map subjected to feature optimization all have a scale greater than that of the m+1th feature map subjected to feature optimization. Hence, the preceding m feature maps may be all subjected to scale-down to obtain the preceding m feature maps subjected to scale-down.

In a possible implementation, the step of performing, by m+1 fusion sub-networks of an mth-level encoding network, fusion on the m+1 feature maps subjected to feature optimization, respectively, to obtain m+1 feature maps encoded at mth level may also include:

performing fusion on at least two of the k−1 feature maps subjected to scale-down, the kth feature map subjected to feature optimization and the m+1−k feature maps subjected to scale-up to obtain a kth feature map encoded at mth level.

For example, the kth fusion sub-network may perform fusion on m+1 feature maps subjected to scale adjustment. In a case where 1<k<m+1, the m+1 feature maps subjected to scale adjustment include the k−1 feature maps subjected to scale-down, the kth feature map subjected to feature optimization and the m+1−k feature maps subjected to scale-up. The k−1 feature maps subjected to scale-down, the kth feature map subjected to feature optimization and the m+1−k feature maps subjected to scale-up may be fused (summed up) to obtain a kth feature map encoded at mth level.

In a possible implementation, in a case where k=1, the m+1 feature maps after the first feature map subjected to feature optimization include the first feature map subjected to feature optimization and the m feature maps subjected to scale-up. The first feature map subjected to feature optimization and the m feature maps subjected to scale-up may be fused (summed up) to obtain the first feature map encoded at mth level.

In a possible implementation, in a case where k=m+1, the m+1 feature maps subjected to scale adjustment include m feature maps subjected to scale-down and the m+1th feature map subjected to feature optimization. The m feature maps subjected to scale-down and the m+1th feature map subjected to feature optimization may be fused (summed up) to obtain the m+1th feature map encoded at mth level.

FIGS. 2a, 2b and 2c show schematic diagrams of the multi-scale fusion process of the image processing method according to an embodiment of the present disclosure. In FIGS. 2a, 2b and 2c, three feature maps to be fused are taken as an example for description.

As shown in FIG. 2a, in a case where k=1, the second and third feature maps may be subjected to scale-up (upsampling) and channel adjustment (1×1 convolution), respectively, to obtain two feature maps having the same scale and number of channels with the first feature map, then, the fused feature map is obtained by summing up these three feature maps.

As shown in FIG. 2b, in a case where k=2, the first feature map may be subjected to scale-down (convolution with a convolution kernel size of 3×3 and a step length of 2), and the third feature map may be subjected to scale-up (upsampling) and channel adjustment (1×1 convolution), to obtain two feature maps having the same scale and number of channels with the second feature map; then, the fused feature map is obtained by summing up these three feature maps.

As shown in FIG. 2c, in a case where k=3, the first and second feature maps may be subjected to scale-down (convolution with a convolution kernel size of 3×3 and a step length of 2). Since the first feature map and the third map are 4 times different in scale, two times of convolution may be performed (convolution kernel size is 3×3, and step length is 2). After the scale-down, two feature maps having the same scale and number of channels with the third feature map are obtained, then the fused feature map is obtained by summing up these three feature maps.

In such manner, it is possible to realize multi-scale fusion of multiple feature maps having different scales, thereby fusing global and local information at each scale and extracting more effective multi-scale features.

In a possible implementation, for the last level in the M-level encoding network (the Mth-level encoding network), the Mth-level encoding network may have a structure similar to that of the mth-level encoding network. The processing performed by the Mth-level encoding network on the M feature maps encoded at M−1th level is also similar to the processing performed by the mth-level encoding network on the m feature maps encoded on m−1th level, and thus is not repeated herein. After the processing by the Mth-level encoding network, M+1 feature maps encoded at Mth level are obtained. For example, when M=3, four feature maps of the scale 4×, 8×, 16× and 32×, respectively are obtained. The present disclosure does not limit the specific value of M.

In such manner, it is possible to realize the entire processing by the M-level encoding network and obtain multiple feature maps of different scales, thereby more effectively extracting global and local feature information of the image to be processed.

In a possible implementation, the step S13 may include:

performing, by a first-level decoding network, scale-up and multi-scale fusion processing on M+1 feature maps encoded at Mth level to obtain M feature maps decoded at first level;

performing, by an nth-level decoding network, scale-up and multi-scale fusion processing on M−n+2 feature maps decoded at n−1th level to obtain M−n+1 feature maps decoded at nth level, n being an integer and 1<n<N≤M;

performing, by an Nth-level decoding network, multi-scale fusion processing on M−N+2 feature maps decoded at N-th level to obtain a prediction result of the image to be processed.

For example, after the processing by the M-level encoding network, M+1 feature maps encoded at Mth level are obtained. The decoding network of each level in the N-level decoding network may in turn process the feature map decoded at the preceding level. The decoding network of each level may include fusion layers, deconvolution layers, convolution layers, residual layers, upsampling layers, etc. For the first-level decoding network, scale-up and multi-scale fusion processing may be performed by the first-level decoding network on M+1 feature maps encoded at Mth level to obtain M feature maps decoded at first level.

In a possible implementation, for the decoding network of any level in the N-level decoding network (the nth-level decoding network, n being an integer and 1<n<N≤M), scale-down and multi-scale fusion processing may be performed by the nth-level decoding network on M−n+2 feature maps decoded at n−1th level to obtain M−n+1 feature maps decoded at nth level.

In a possible implementation, the step of performing, by the nth-level decoding network, scale-up and multi-scale fusion processing on M−n+2 feature maps decoded at n−1th level to obtain M−n+1 feature maps decoded at nth level may include:

performing fusion and scale-up on M−n+2 feature maps decoded at n−1th level to obtain M−n+1 feature maps subjected to scale-up; and performing fusion on the M−n+1 feature maps subjected to scale-up to obtain M−n+1 feature maps decoded at nth level.

In a possible implementation, the step of performing fusion and scale-up on M−n+2 feature maps decoded at n−1th level to obtain M−n+1 feature maps subjected to scale-up may include:

performing, by M−n+1 first fusion sub-networks of an nth-level decoding network, fusion on M−n+2 feature maps decoded at n−1th level to obtain M−n+1 feature maps subjected to fusion; performing, by a deconvolution sub-network of an nth-level decoding network, scale-up on M−n+1 feature maps subjected to fusion, respectively, to obtain M−n+1 feature maps subjected to scale-up.

For example, the M−n+2 feature maps decoded at n−1th level may be fused first, wherein the amount of feature maps is reduced while fusing multi-scale information. M−n+1 first fusion sub-networks may be provided, which correspond to first M−n+1 feature maps in the M−n+2 feature maps. For example, if the feature maps to be fused include four feature maps having the scale of 4×, 8×, 16× and 32×, then three first fusion sub-networks may be provided to perform fusion to obtain three feature maps having the scale of 4×, 8× and 16×.

In a possible implementation, the network structure of the M−n+1 first fusion sub-networks of the nth-level decoding network may be similar to the network structure of the m+1 fusion sub-networks of the mth-level encoding network. For example, for the qth first fusion sub-network (1≤q≤M−n+1), the qth first fusion sub-network may first adjust the scale of M−n+2 feature maps to be the scale of the qth feature map decoded at n−1th level, and then fuse the M−n+2 feature maps subjected to scale adjustment to obtain the qth feature map subjected to fusion. In such manner, M−n+1 feature maps subjected to fusion are obtained. The specific process of scale adjustment and fusion will not be repeated here.

In a possible implementation, the M−n+1 feature maps subjected to fusion may be scaled up respectively by the deconvolution network of the nth-level decoding network. For example, the three feature maps subjected to fusion having the scale of 4×, 8× and 16× may be scaled up to three feature maps having the scale of 2×, 4× and 8×. After the scale-up, M−n+1 feature maps subjected to scale-up are obtained.

In a possible implementation, the step of fusing the M−n+1 feature maps subjected to scale-up to obtain M−n+1 feature maps decoded at nth level may include:

performing, by M−n+1 second fusion sub-networks of an nth-level decoding network, fusion on the M−n+1 feature maps subjected to scale-up to obtain M−n+1 feature maps subjected to fusion; and performing, by a feature optimizing sub-network of an nth-level decoding network, optimization on the M−n+1 feature maps subjected to fusion, respectively, to obtain M−n+1 feature maps decoded at nth level.

For example, after the M−n+1 feature maps subjected to scale-up are obtained, scale adjustment and fusion may be performed respectively by M−n+1 second fusion sub-networks on the M−n+1 feature maps to obtain M−n+1 feature maps subjected to fusion. The specific process of scale adjustment and fusion will not be repeated here.

In a possible implementation, the M−n+1 feature maps subjected to fusion may be optimized respectively by the feature optimizing sub-networks of the nth-level decoding network, wherein each feature optimizing sub-network may include at least one basic block. After the feature optimization, M−n+1 feature maps decoded at nth level are obtained. The specific process of feature optimization will not be repeated here.

In a possible implementation, the process of multi-scale fusion and feature optimization of the nth-level decoding network may be repeated multiple times to further fuse global and local information of different scales. The present disclosure does not limit the number of times of multi-scale fusion and feature optimization.

In such manner, it is possible to scale up feature maps of multiple scales as well as to fuse information of feature maps of multiple scales, thus remaining multi-scale information of the feature maps and improving the quality of the prediction result.

In a possible implementation, the step of performing, by an Nth-level decoding network, multi-scale fusion processing on M−N+2 feature maps decoded at N−1th level to obtain a prediction result of the image to be processed may include:

performing multi-scale fusion on M−N+2 feature maps decoded at N−1th level to obtain a target feature map decoded at Nth level; and determining a prediction result of the image to be processed according to the target feature map decoded at Nth level.

For example, after the processing by the N−1th level decoding network, M−N+2 feature maps are obtained, a feature map having the greatest scale among which has a scale equal to the scale of the image to be processed (a feature map having a scale of 1×). The last level of the N-level decoding network (the Nth-level decoding network) may perform multi-scale fusion processing on M−N+2 feature maps decoded at N−1th level. In a case where N=M, there are 2 feature maps decoded at N−1th level (e.g., feature maps having the scale of 1× and 2×); in a case where N<M, there are more than 2 feature maps decoded at N−1th level (e.g., feature maps having the scale of 1×, 2× and 4×). The present disclosure does not limit this.

In a possible implementation, multi-scale fusion (scale adjustment and fusion) may be performed by the fusion sub-network of the Nth-level decoding network on M−N+2 feature maps to obtain a target feature map decoded at Nth level. The target feature map may have a scale consistent with the scale of the image to be processed. The specific process of scale adjustment and fusion will not be repeated here.

In a possible implementation, the step of determining a prediction result of the image to be processed according to the target feature map decoded at Nth level may include:

performing optimization on the target feature map decoded at Nth level to obtain a predicted density map of the image to be processed; and determining a prediction result of the image to be processed according to the predicted density map.

For example, after the target feature map decoded at Nth level is obtained, the target feature map may be further optimized. The target feature map may be further optimized by at least one of a plurality of second convolution layers (convolution kernel size is 3×3, and step length is 1), a plurality of basic blocks (comprising second convolution layers and residual layers), and at least one third convolution layer (convolution kernel size is 1×1), so as to obtain the predicted density map of the image to be processed. The present disclosure does not limit the specific method of optimization.

In a possible implementation, it is possible to determine the prediction result of the image to be processed according to the predicted density map. The predicted density map may directly serve as the prediction result of the image to be processed; or the predicted density map may be subjected to further processing (e.g., processing by softmax layers, etc.) to obtain the prediction result of the image to be processed.

In such manner, an N-level decoding network fuses global information and local information for multiple times during the scale-up process, thereby improving the quality of the prediction result.

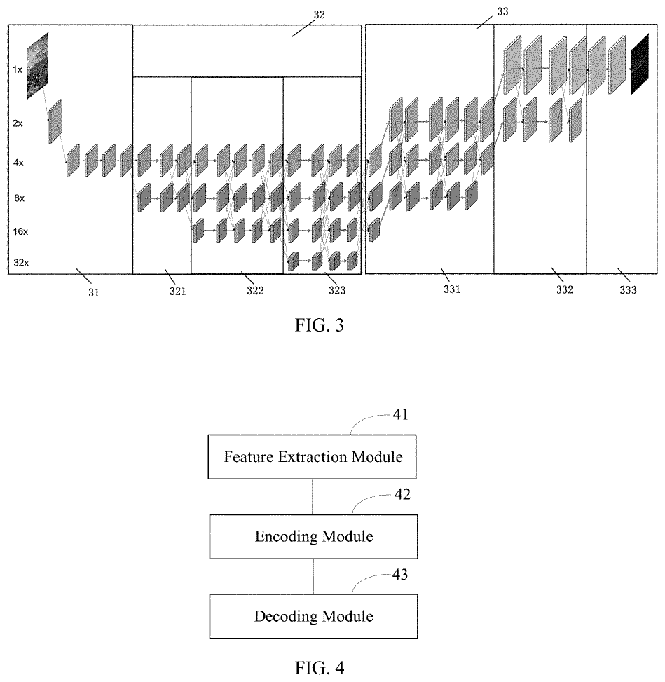

FIG. 3 shows a schematic diagram of the network configuration of the image processing method according to an embodiment of the present disclosure. As shown in FIG. 3, the neural network for implementing the image processing method according to an embodiment of the present disclosure may comprise a feature extraction network 31, a three-level encoding network 32 (comprising a first-level encoding network 321, a second-level encoding network 322 and a third-level encoding network 323) and a three-level decoding network 33 (comprising a first-level decoding network 331, a second-level decoding network 332 and a third-level decoding network 333).

In a possible implementation, as shown in FIG. 3, the image to be processed (scale is 1×) may be input into the feature extraction network 31 to be processed. The image to be processed is subjected to convolution by two continuous first convolution layers (convolution kernel size is 3×3, and step length is 2) to obtain a feature map subjected to convolution (scale is 4×, i.e., width and height of the feature map being ¼ the width and the height of the image to be processed); the feature map subjected to convolution (scale is 4×) is then optimized by three second convolution layers (convolution kernel size is 3×3, and step length is 1) to obtain a first feature map (scale is 4×).

In a possible implementation, the first feature map (scale is 4×) may be input into the first-level encoding network 321. The first feature map is subjected to convolution (scale-down) by a convolution sub-network (including first convolution layers) to obtain a second feature map (scale is 8×, i.e., width and height of the feature map being ⅛ the width and the height of the image to be processed); the first feature map and the second feature map are respectively subjected to feature optimization by a feature optimizing sub-network (at least one basic block, comprising second convolution layers and residual layers) to obtain a first feature map subjected to feature optimization and a second feature map subjected to feature optimization; and the first feature map subjected to feature optimization and the second feature map subjected to feature optimization are subjected to multi-scale fusion to obtain a first feature map encoded at first level and a second feature map encoded at first level.

In a possible implementation, the first feature map encoded at first level (scale is 4×) and the second feature map encoded at first level (scale is 8×) may be input into the second-level encoding network 322. The first feature map encoded at first level and the second feature map encoded at first level are respectively subjected to convolution (scale-down) and fusion by a convolution sub-network (including at least one first convolution layer) to obtain a third feature map (scale is 16×, i.e., width and height of the feature map being 1/16 the width and the height of the image to be processed); the first, second and third feature maps are respectively subjected to feature optimization by a feature optimizing sub-network (at least one basic block, comprising second convolution layers and residual layers) to obtain a first, second and third feature maps subjected to feature optimization; the first, second and third feature maps subjected to feature optimization are subjected to multi-scale fusion to obtain a first, second and third feature maps subjected to fusion; thence, the first, second and third feature maps subjected to fusion are optimized and fused again to obtain a first, second and third feature maps encoded at second level.

In a possible implementation, the first, second and third feature maps encoded at second level (4×, 8× and 16×) may be input into the third-level encoding network 323. The first, second and third feature maps encoded at second level are subjected to convolution (scale-down) and fusion, respectively by a convolution sub-network (including at least one first convolution layer), to obtain a fourth feature map (scale 32×, i.e., width and height of the feature map being 1/32 the width and the height of the image to be processed); the first, second, third and fourth feature maps are subjected to feature optimization respectively by a feature optimizing sub-network (at least one basic block, comprising second convolution layers and residual layers) to obtain a first, second, third and fourth feature maps subjected to feature optimization; the first, second, third and fourth feature maps subjected to feature optimization are subjected to multi-scale fusion to obtain a first, second, third and fourth feature maps subjected to fusion; thence, the first, second, and third feature maps subjected to fusion are optimized again to obtain a first, second, third and fourth feature maps encoded at third level.

In a possible implementation, the first, second, third and fourth feature maps encoded at third level (scales are 4×, 8×, 16× and 32×) into a first-level decoding network 331. The first, second, third and fourth feature maps encoded at third level are fused by three first fusion sub-networks to obtain three feature maps subjected to fusion (scales are 4×, 8× and 16×); the three feature maps subjected to fusion are deconvolutionized (scaled-up) to obtain three feature maps subjected to scale-up (scales are 2×, 4× and 8×); and the three feature maps scaled-up are subjected to multi-scale fusion, feature optimization, further multi-scale fusion and further feature optimization, to obtain three feature maps decoded at first-level (scales are 2×, 4× and 8×).

In a possible implementation, the three feature maps decoded at first-level (scales are 2×, 4× and 8×) may be input into the second-level decoding network 332. The three feature maps decoded at first-level are fused by two first fusion sub-networks to obtain two feature maps subjected to fusion (scales are 2× and 4×); then, the two feature maps subjected to fusion are deconvolutionized (scaled-up) to obtain two feature maps subjected to scale-up (scales are 1× and 2×); and the two feature maps subjected to scale-up are subjected to multi-scale fusion, feature optimization and further multi-scale fusion, to obtain two feature maps decoded at second level (scales are 1× and 2×).

In a possible implementation, the two feature maps decoded at second level (scales are 1× and 2×) may be input into the third-level decoding network 333. The two feature maps decoded at second level are fused by a first fusion sub-network to obtain a feature map subjected to fusion (scale is 1×); then, the feature map subjected to fusion are optimized by a second convolution layer and a third convolution layer (convolution kernel size is 1×1) to obtain a predicted density map (scale is 1×) of the image to be processed.

In a possible implementation, a normalization layer may be added following each convolution layer to perform normalization processing on the convolution result at each level, thereby obtaining normalized convolution results and improving the precision of the convolution results.

In a possible implementation, before applying the neural network of the present disclosure, the neural network may be trained. The image processing method according to embodiments of the present disclosure may further comprise:

training the feature extraction network, the M-level encoding network and the N-level decoding network according to a preset training set, the training set containing a plurality of sample images which have been labeled.

For example, a plurality of sample images having been labeled may be preset, each of the sample images having labeled information such as positions and amount of pedestrians in the sample images. The plurality of sample images having been labeled may form a training set to train the feature extraction network, the M-level encoding network and the N-level decoding network.

In a possible implementation, the sample images may be input into the feature extraction network and processed by the feature extraction network, the M-level encoding network and the N-level decoding network to output a prediction result of the sample images; according to the prediction result and the labeled information of the sample images, network losses of the feature extraction network, the M-level encoding network and the N-level decoding network are determined; network parameters of the feature extraction network, the M-level encoding network and the N-level decoding network are adjusted according to the network losses; and when a preset training conditions are satisfied, trained feature extraction network, M-level encoding network and N-level decoding network are obtained. The present disclosure does not limit the specific training process.

In such manner, high-precision feature extraction network, M-level encoding network and N-level decoding network are obtained.

According to the image processing method of the embodiments of the present disclosure, it is possible to obtain feature maps of small scales by convolution operation with a step length, extract more effective multi-scale information by continuous fusion of global and local information in the network structure, and facilitate the extraction of information at the current scale using information at other scales, thereby improving the robustness of the recognition of multi-scale targets (e.g., pedestrians) by the network; it is also possible to fuse multi-scale information while scaling up feature maps in the decoding network, maintaining multi-scale information, improving the quality of the generated density map, thereby improving the prediction accuracy of the model.

The image processing method of the embodiments of the present disclosure is applicable to application scenarios such as intelligent video analysis, security monitoring, and so on, to recognize targets in the scenario (e.g., pedestrians, vehicles, etc.) and predict the amount and the distribution of targets in the scenario, thereby analyzing behaviors of crowd in the current scenario.

It is appreciated that the afore-mentioned method embodiments of the present disclosure may be combined with one another to form a combined embodiment without departing from the principle and the logics, which, due to limited space, will not be repeatedly described in the present disclosure. A person skilled in the art should understand that the specific order of execution of the steps in the afore-described methods according to the specific embodiments should be determined by the functions and possible inherent logics of the steps.

In addition, the present disclosure further provides an image processing device, an electronic apparatus, a computer readable medium and a program which are all capable of realizing any image processing method provided by the present disclosure. For the corresponding technical solution and description which will not be repeated, reference may be made to the corresponding description of the method.

FIG. 4 shows a frame chart of the image processing device according to an embodiment of the present disclosure. As shown in FIG. 4, the image processing device comprises:

a feature extraction module 41 configured to perform, by a feature extraction network, feature extraction on an image to be processed, to obtain a first feature map of the image to be processed;

an encoding module 42 configured to perform, by an M-level encoding network, scale-down and multi-scale fusion processing on the first feature map to obtain a plurality of feature maps which are encoded, each feature map of the plurality of feature maps having a different scale; and

a decoding module 43 configured to perform, by an N-level decoding network, scale-up and multi-scale fusion processing on a plurality of feature maps which are encoded to obtain a prediction result of the image to be processed, M, N being integers greater than 1.

In a possible implementation, the encoding module comprises: a first encoding sub-module configured to perform, by a first-level encoding network, scale-down and multi-scale fusion processing on the first feature map to obtain a first feature map encoded at first level and a second feature map encoded at first level; a second encoding sub-module configured to perform, by an mth-level encoding network, scale-down and multi-scale fusion processing on m feature maps encoded at m−1th level to obtain m+1 feature maps encoded at mth level, where m is an integer and 1<m<M; and a third encoding sub-module configured to perform, by an Mth-level encoding network, scale-down and multi-scale fusion processing on M feature maps which are encoded at M−1th level to obtain M+1 feature maps encoded at Mth level.

In a possible implementation, the first encoding sub-module comprises: a first scale-down sub-module configured to perform scale-down on the first feature map to obtain a second feature map; and a first fusion sub-module configured to perform fusion on the first feature map and the second feature map to obtain a first feature map encoded at first level and a second feature map encoded at first level.

In a possible implementation, the second encoding sub-module comprises: a second scale-down sub-module configured to perform scale-down and fusion on m feature maps encoded at m−1th level to obtain an m+1th feature map, the m+1th feature map having a scale smaller than a scale of the m feature maps encoded at m−1th level; and a second fusion sub-module configured to perform fusion on the m feature maps encoded at m−1th level and the m+1th feature map to obtain m+1 feature maps encoded at mth level.

In a possible implementation, the second scale-down sub-module is configured to perform, by a convolution sub-network of an mth-level encoding network, scale-down on m feature maps encoded at m−1th level, respectively, to obtain m feature maps subjected to scale-down, the m feature maps subjected to scale-down having a scale equal to a scale of the m+1th feature map; and to perform feature fusion on the m feature maps subjected to scale-down to obtain the m+1th feature map.

In a possible implementation, the second fusion sub-module is configured to perform, by a feature optimizing sub-network of an mth-level encoding network, feature optimization on m feature maps encoded at m−1th level and the m+1th feature map, respectively, to obtain m+1 feature maps subjected to feature optimization; and to perform, by m+1 fusion sub-networks of an mth-level encoding network, fusion on the m+1 feature maps subjected to feature optimization, respectively, to obtain m+1 feature maps encoded at mth level.

In a possible implementation, the convolution sub-network includes at least one first convolution layer, the first convolution layer having a convolution kernel size of 3×3 and a step length of 2; the feature optimizing sub-network includes at least two second convolution layers and residual layers, the second convolution layer having a convolution kernel size of 3×3 and a step length of 1; the m+1 fusion sub-networks are corresponding to m+1 feature maps subjected to optimization.

In a possible implementation, for a kth fusion sub-network of m+1 fusion sub-networks, performing, by m+1 fusion sub-networks of an mth-level encoding network, fusion on the m+1 feature maps subjected to feature optimization, respectively, to obtain m+1 feature maps encoded at mth level includes: performing, by at least one first convolution layer, scale-down on k−1 feature maps having a scale greater than that of the kth feature map subjected to feature optimization to obtain k−1 feature maps subjected to scale-down, the k−1 feature maps subjected to scale-down having a scale equal to a scale of the kth feature map subjected to feature optimization; and/or performing, by an upsampling layer and a third convolution layer, scale-up and channel adjustment on m+1−k feature maps having a scale smaller than that of the kth feature map subjected to feature optimization to obtain m+1−k feature maps subjected to scale-up, the m+1−k feature maps subjected to scale-up having a scale equal to a scale of the kth feature map subjected to feature optimization; wherein, k is an integer and 1≤k≤m+1, the third convolution layer has a convolution kernel size of 1×1.

In a possible implementation, performing, by m+1 fusion sub-networks of an mth-level encoding network, fusion on the m+1 feature maps subjected to feature optimization, respectively, to obtain m+1 feature maps encoded at mth level further includes: performing fusion on at least two of the k−1 feature maps subjected to scale-down, the kth feature map subjected to feature optimization and the m+1−k feature maps subjected to scale-up, to obtain a kth feature map encoded at mth level.

In a possible implementation, the decoding module comprises: a first decoding sub-module configured to perform, by a first-level decoding network, scale-up and multi-scale fusion processing on M+1 feature maps encoded at Mth level to obtain M feature maps decoded at first level; a second decoding sub-module configured to perform, by an nth-level decoding network, scale-up and multi-scale fusion processing on M−n+2 feature maps decoded at n−1th level to obtain M−n+1 feature maps decoded at nth level, n being an integer and 1<n<N SM; and a third decoding sub-module configured to perform, by an Nth-level decoding network, multi-scale fusion on M−N+2 feature maps decoded at N-th level to obtain a prediction result of the image to be processed.

In a possible implementation, the second decoding sub-module comprises: a scale-up sub-module configured to perform fusion and scale-up on M−n+2 feature maps decoded at n−1th level to obtain M−n+1 feature maps subjected to scale-up; and a third fusion sub-module configured to perform fusion on the M−n+1 feature maps subjected to scale-up to obtain M−n+1 feature maps decoded at nth level.

In a possible implementation, the third decoding sub-module comprises: a fourth fusion sub-module configured to perform multi-scale fusion on the M−n+2 feature maps decoded at n−1th level to obtain a target feature map decoded at Nth level; and a result determination sub-module configured to determine a prediction result of the image to be processed according to the target feature map decoded at Nth level.

In a possible implementation, the scale-up sub-module is configured to perform, by M−n+1 first fusion sub-networks of an nth-level decoding network, fusion on M−n+2 feature maps decoded at n−1th level to obtain M−n+1 feature maps subjected to fusion; and to perform, by a deconvolution sub-network of an nth-level decoding network, scale-up on the M−n+1 feature maps subjected to fusion, respectively, to obtain M−n+1 feature maps subjected to scale-up.

In a possible implementation, the third fusion sub-module is configured to perform, by M−n+1 second fusion sub-networks of an nth-level decoding network, fusion on the M−n+1 feature maps subjected to scale-up to obtain M−n+1 feature maps subjected to fusion; and to perform, by a feature optimizing sub-network of an nth-level decoding network, optimization on the M−n+1 feature maps subjected to fusion, respectively, to obtain M−n+1 feature maps decoded at nth level.

In a possible implementation, the result determination sub-module is configured to perform optimization on the target feature map decoded at Nth level to obtain a predicted density map of the image to be processed; and to determine a prediction result of the image to be processed according to the predicted density map.

In a possible implementation, the feature extraction module comprises: a convolution sub-module configured to perform, by at least one first convolution layer of the feature extraction network, convolution on the image to be processed to obtain a feature map subjected to convolution; and an optimization module configured to perform, by at least one second convolution layer of the feature extraction network, optimization on the feature map subjected to convolution to obtain a first feature map of the image to be processed.

In a possible implementation, the first convolution layer has a convolution kernel size of 3×3 and a step length of 2; the second convolution layer has a convolution kernel size of 3×3 and a step length of 1.

In a possible implementation, the device further comprises: a training sub-module configured to train the feature extraction network, the M-level encoding network and the N-level decoding network according to a preset training set, the training set containing a plurality of sample images which have been labeled.

In some embodiments, functions or modules of the device provided by the embodiments of the present disclosure may be configured to execute the method described in the above method embodiments. For the specific implementation of the functions or modules, reference may be made to the afore-described method embodiments, which will not be repeated here to be concise.

Embodiments of the present disclosure further provide a computer readable storage medium having computer program instructions stored thereon, the computer program instructions implementing the method described above when being executed by a processor.

The computer readable storage medium may be a non-volatile computer readable storage medium or a volatile computer readable storage medium.

Embodiments of the present disclosure further provide an electronic apparatus, comprising: a processor, and a memory configured to store instructions executable by the processor, wherein the processor is configured to invoke the instructions stored in the memory to execute the afore-described method.

Embodiments of the present disclosure further provide a computer program, the computer program including computer readable codes which, when run in an electronic apparatus, a processor of the electronic apparatus executes the afore-described method.

The electronic apparatus may be provided as a terminal, a server or an apparatus in other forms.

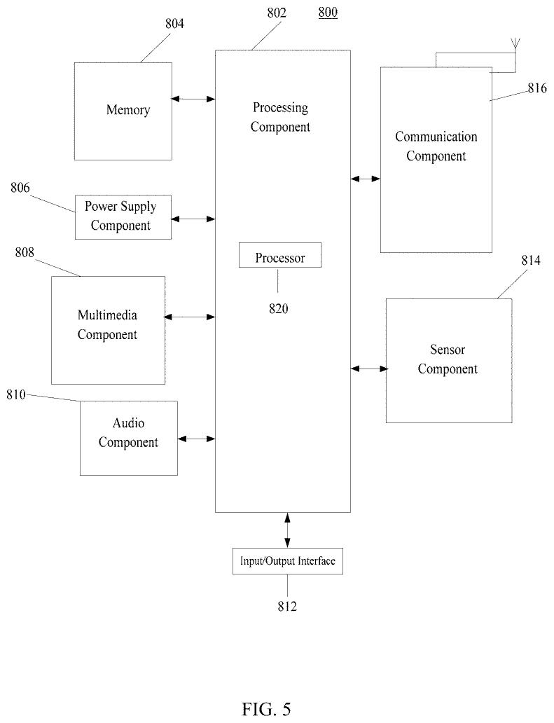

FIG. 5 shows a frame chart of an electronic apparatus 800 according to an embodiment of the present disclosure. For example, the electronic apparatus 800 may be a terminal such as mobile phone, computer, digital broadcast terminal, message transmitting and receiving apparatus, game console, tablet apparatus, medical apparatus, gym equipment, personal digital assistant, etc.

Referring to FIG. 5, the electronic apparatus 800 may include one or more components of: a processing component 802, a memory 804, a power supply component 806, a multimedia component 808, an audio component 810, Input/Output (I/O) interface 812, a sensor component 814, and a communication component 816.

The processing component 802 generally controls the overall operation of the electronic apparatus 800, such as operations associated with display, phone calls, data communications, camera operation and recording operation. The processing component 802 may include one or more processor 820 to execute instructions, so as to complete all or a part of the steps of the afore-described method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the electronic apparatus 800. Examples of the data include instructions of any application program or method to be operated on the electronic apparatus 800, contact data, phone book data, messages, images, videos, etc. The memory 804 may be implemented by a volatile or non-volatile storage device of any type (such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk) or their combinations.

The power supply component 806 supplies electric power for various components of the electronic apparatus 800. The power supply component 806 may comprise a power source management system, one or more power source and other components associated with generation, management and distribution of electric power for the electronic apparatus 800.

The multimedia component 808 comprises a screen disposed between the electronic apparatus 800 and the user and providing an output interface. In some embodiments, the screen may include a liquid crystal display (LCD) and a touch panel (TP). If the screen includes a touch panel, the screen may be implemented as a touch screen to receive input signals from the user. The touch panel includes one or more touch sensor to sense touch, slide and gestures on the touch panel. The touch sensor may not only sense a border of a touch or sliding action but also detect duration time and pressure associated with the touch or sliding action. In some embodiments, the multimedia component 808 includes a front camera and/or a rear camera. When the electronic apparatus 800 is in an operation mode, such as a shooting mode or a video mode, the front camera and/or the rear camera may receive external multimedia data. Each front camera and rear camera may be a fixed optical lens system or may have a focal length and optical zooming capability.

The audio component 810 is configured to output and/or input audio signals. For example, the audio component 810 includes a MIC; when the electronic apparatus 800 is in an operation mode, such as calling mode, recording mode and speech recognition mode, the MIC is configured to receive external audio signals. The received audio signal may be further stored in the memory 804 or is sent by the communication component 816. In some embodiments, the audio component 810 further comprises a speaker for outputting audio signals.

The I/O interface 812 provides an interface between the processing component 802 and an external interface module. The external interface module may be keyboards, click wheels, buttons, etc. These buttons may include, but are not limited to, home button, volume button, activation button and locking button.

The sensor component 814 includes one or more sensors configured to provide state assessment in various aspects for the electronic apparatus 800. For example, the sensor component 814 may detect an on/off state of the electronic apparatus 800, relative positioning of components, for instance, the components being the display and the keypad of the electronic apparatus 800. The sensor component 814 may also detect a change of position of the electronic apparatus 800 or one component of the electronic apparatus 800, presence or absence of contact between the user and the electronic apparatus 800, location or acceleration/deceleration of the electronic apparatus 800, and a change of temperature of the electronic apparatus 800. The sensor component 814 may also include an approaching sensor configured to detect presence of a nearby object when there is not any physical contact. The sensor component 814 may further include an optical sensor such as CMOS or CCD image sensor, configured to be used in imaging applications. In some embodiments, the sensor component 814 may also include an acceleration sensor, a gyro-sensor, a magnetic sensor, a pressure sensor or a temperature sensor.

The communication component 816 is configured to facilitate communications in a wired or wireless manner between the electronic apparatus 800 and other apparatus. The electronic apparatus 800 may access a wireless network based on communication standards such as WiFi, 2G or 3G or a combination thereof. In an exemplary embodiment, the communication component 816 receives broadcast signals from an external broadcast management system or broadcast related information via a broadcast channel. In an exemplary embodiment, the communication component 816 further comprises a near-field communication (NFC) module to facilitate short distance communication. For example, the NFC module may be implemented based on Radio Frequency Identification (RFID) technology, Infrared Data Association (IrDA) technology, Ultra-Wideband (UWB) technology, Bluetooth (BT) technology and other technologies.

In an exemplary embodiment, the electronic apparatus 800 may be implemented by one or more of Application-Specific Integrated Circuit (ASIC), Digital Signal Processor (DSP), Digital Signal Processing Device (DSPD), Programmable Logic Device (PLD), Field Programmable Gate Array (FPGA), a controller, a microcontroller, a microprocessor or other electronic elements, to execute above described methods.

In an exemplary embodiment, there is further provided a non-volatile computer readable storage medium such as the memory 804 including computer program instructions. The above described computer program instructions may be executed by the processor 820 of the electronic apparatus 800 to complete the afore-described method.

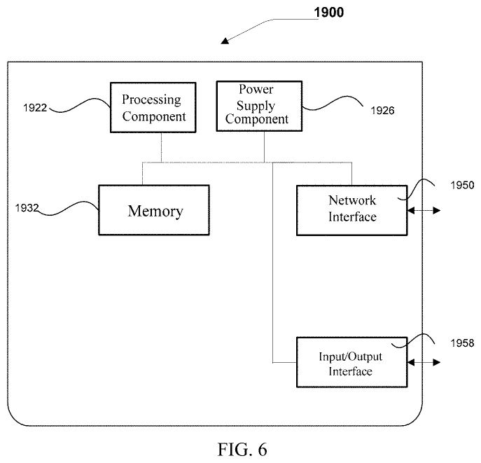

FIG. 6 shows a frame chart of an electronic apparatus 1900 according to an embodiment of the present disclosure. For example, the electronic apparatus 1900 may be provided as a server. With reference to FIG. 6, the electronic apparatus 1900 comprises a processing component 1922 which further comprises one or more processors, and a memory resource represented by a memory 1932 which is configured to store instructions executable by the processing component 1922, such as an application program. The application program stored in the memory 1932 may include one or more modules each corresponding to a set of instructions. In addition, the processing component 1922 is configured to execute the above described instructions to execute the afore-described method.

The electronic apparatus 1900 may also include a power supply component 1926 configured to execute power supply management of the electronic apparatus 1900, a wired or wireless network interface 1950 configured to connected the electronic apparatus 1900 to a network, and an Input/Output (I/O) interface 1958. The electronic apparatus 1900 may operate based on an operation system stored in the memory 1932, such as Windows Server™, Mac OS X™, Unix™, Linux™, FreeBSD™ and the like.

In an exemplary embodiment, there is further provided a non-volatile computer readable storage medium, for example, the memory 1932 including computer program instructions. The above described computer program instructions are executable by the processing component 1922 of the electronic apparatus 1900 to complete the afore-described method.

The present disclosure may be a system, a method, and/or a computer program product. The computer program product may include a computer readable storage medium having computer readable program instructions for causing a processor to implement the aspects of the present disclosure stored thereon.

The computer readable storage medium can be a tangible device that can retain and store instructions used by an instruction executing apparatus. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal itself, such as radio waves or other freely propagating electromagnetic waves, electromagnetic waves propagating by a waveguide or other transmission media (e.g., light pulses passing by a fiber-optic cable), or electrical signal transmitted by a wire.

Computer readable program instructions described herein can be downloaded to each computing/processing device from a computer readable storage medium or to an external computer or external storage device via network, for example, the Internet, local area network, wide area network and/or wireless network. The network may comprise copper transmission cables, optical fibers transmission, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario relating to remote computer, the remote computer may be connected to the user's computer by any type of network, including local area network (LAN) or wide area network (WAN), or connected to an external computer (for example, by the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowcharts and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices.

These computer readable program instructions may also be stored in a computer readable storage medium, wherein the instructions cause a computer, a programmable data processing device and/or other apparatuses to function in a particular manner, thereby the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other apparatuses to have a series of operational steps executed on the computer, other programmable devices or other apparatuses, so as to produce a computer implemented process, such that the instructions executed on the computer, other programmable devices or other apparatuses implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems executing the specified functions or acts, or by combinations of dedicated hardware and computer instructions.

Without devastating the logics, different embodiments of the present disclosure may be combined. The embodiments are described with particular emphasis. For the portion that is not the emphasis of one embodiment, reference may be made to the description of other embodiments.

Although the embodiments of the present disclosure have been described above, it will be appreciated that the above descriptions are merely exemplary, but not exhaustive; and that the disclosed embodiments are not limiting. A number of variations and modifications may be apparently to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
performing, by a feature extraction network, feature extraction on an image to be processed, to obtain a first feature map of the image to be processed;
performing, by an M-level encoding network, scale-down and multi-scale fusion processing on the first feature map to obtain a plurality of feature maps which are encoded, each of the plurality of feature maps having a different scale; and
performing, by an N-level decoding network, scale-up and multi-scale fusion processing on the plurality of feature maps which are encoded to obtain a prediction result of the image to be processed, M, N being integers greater than 1.

2. The method according to claim 1, wherein performing, by the M-level encoding network, scale-down and multi-scale fusion processing on the first feature map to obtain the plurality of feature maps which are encoded comprises:
performing, by a first-level encoding network, scale-down and multi-scale fusion processing on the first feature map to obtain a first feature map encoded at first level and a second feature map encoded at first level;
performing, by an mth-level encoding network, scale-down and multi-scale fusion processing on m feature maps encoded at m−1th level to obtain m+1 feature maps encoded at mth level, where m is an integer and 1<m<M; and
performing, by the Mth-level encoding network, scale-down and multi-scale fusion processing on M feature maps encoded at M−1th level to obtain M+1 feature maps encoded at Mth level.

3. The method according to claim 2, wherein performing, by the first-level encoding network, scale-down and multi-scale fusion processing on the first feature map to obtain the first feature map encoded at first level and the second feature map encoded at first level comprises:
performing scale-down on the first feature map to obtain a second feature map; and
performing fusion on the first feature map and the second feature map to obtain the first feature map encoded at first level and the second feature map encoded at first level.

4. The method according to claim 2, wherein performing, by the mth-level encoding network, scale-down and multi-scale fusion processing on the m feature maps encoded at m−1th level to obtain the m+1 feature maps encoded at mth level comprises:
performing scale-down and fusion on the m feature maps encoded at m−1th level to obtain an m+1th feature map, the m+1th feature map having a scale smaller than a scale of the m feature maps encoded at m−1th level; and
performing fusion on the m feature maps encoded at m−1th level and the m+1th feature map to obtain the m+1 feature maps encoded at mth level.

5. The method according to claim 4, wherein performing scale-down and fusion on the m feature maps encoded at m−1th level to obtain the m+1th feature map comprises:
performing scale-down on the m feature maps encoded at m−1th level by a convolution sub-network of the mth-level encoding network respectively to obtain m feature maps subjected to scale-down, the m feature maps subjected to scale-down having a scale equal to a scale of the m+1th feature map; and
performing feature fusion on the m feature maps subjected to scale-down to obtain the m+1th feature map.

6. The method according to claim 4, wherein performing fusion on the m feature maps encoded at m−1th level and the m+1th feature map to obtain the m+1 feature maps encoded at mth level comprises:
performing, by a feature optimizing sub-network of the mth-level encoding network, feature optimization on the m feature maps encoded at m−1th level and the m+1th feature map, respectively, to obtain m+1 feature maps subjected to feature optimization; and
performing, by m+1 fusion sub-networks of the mth-level encoding network, fusion on the m+1 feature maps subjected to feature optimization, respectively, to obtain the m+1 feature maps encoded at mth level.

7. The method according to claim 5, wherein the convolution sub-network comprises at least one first convolution layer, the first convolution layer having a convolution kernel size of 3×3 and a step length of 2;
the feature optimizing sub-network comprises at least two second convolution layers and residual layers, the second convolution layer having a convolution kernel size of 3×3 and a step length of 1;
the m+1 fusion sub-networks are corresponding to the m+1 feature maps subjected to optimization.

8. The method according to claim 7, wherein for a kth fusion sub-network of the m+1 fusion sub-networks, performing, by the m+1 fusion sub-networks of the mth-level encoding network, fusion on the m+1 feature maps subjected to feature optimization, respectively, to obtain the m+1 feature maps encoded at mth level comprises:
performing, by the at least one first convolution layer, scale-down on k−1 feature maps having a scale greater than that of a kth feature map subjected to feature optimization to obtain k−1 feature maps subjected to scale-down, the k−1 feature maps subjected to scale-down having a scale equal to a scale of the kth feature map subjected to feature optimization; and/or
performing, by an upsampling layer and a third convolution layer, scale-up and channel adjustment on m+1−k feature maps having a scale smaller than that of the kth feature map subjected to feature optimization to obtain m+1−k feature maps subjected to scale-up, the m+1−k feature maps subjected to scale-up having a scale equal to a scale of the kth feature map subjected to feature optimization;
wherein, k is an integer and 1≤k≤m+1, the third convolution layer has a convolution kernel size of 1×1.

9. The method according to claim 8, wherein performing, by the m+1 fusion sub-networks of the mth-level encoding network, fusion on the m+1 feature maps subjected to feature optimization, respectively, to obtain the m+1 feature maps encoded at mth level further comprises:
performing fusion on at least two of the k−1 feature maps subjected to scale-down, the kth feature map subjected to feature optimization and the m+1−k feature maps subjected to scale-up to obtain a kth feature map encoded at mth level.

10. The method according to claim 2, wherein performing, by the N-level decoding network, scale-up and multi-scale fusion processing on the plurality of feature maps which are encoded to obtain the prediction result of the image to be processed comprises:
performing, by a first-level decoding network, scale-up and multi-scale fusion processing on M+1 feature maps encoded at Mth level to obtain M feature maps decoded at first level;
performing, by an nth-level decoding network, scale-up and multi-scale fusion processing on M−n+2 feature maps decoded at n−1th level to obtain M−n+1 feature maps decoded at nth level, n being an integer and 1<n<N≤M; and
performing, by an Nth-level decoding network, multi-scale fusion processing on M−N+2 feature maps decoded at N-th level to obtain the prediction result of the image to be processed.

11. The method according to claim 10, wherein performing, by the nth-level decoding network, scale-up and multi-scale fusion processing on M−n+2 feature maps decoded at n-th level to obtain the M−n+1 feature maps decoded at nth level comprises:
performing fusion and scale-up on the M−n+2 feature maps decoded at n−1th level to obtain M−n+1 feature maps subjected to scale-up; and
performing fusion on the M−n+1 feature maps subjected to scale-up to obtain the M−n+1 feature maps decoded at nth level.

12. The method according to claim 10, wherein performing, by the Nth-level decoding network, multi-scale fusion processing on the M−N+2 feature maps decoded at N−1th level to obtain the prediction result of the image to be processed comprises:
performing multi-scale fusion on the M−N+2 feature maps decoded at N−1th level to obtain a target feature map decoded at Nth level; and
determining the prediction result of the image to be processed according to the target feature map decoded at Nth level.

13. The method according to claim 11, wherein performing fusion and scale-up on the M−n+2 feature maps decoded at n−1th level to obtain the M−n+1 feature maps subjected to scale-up comprises:
performing, by M−n+1 first fusion sub-networks of the nth-level decoding network, fusion on the M−n+2 feature maps decoded at n−1th level to obtain M−n+1 feature maps subjected to fusion; and
performing, by a deconvolution sub-network of the nth-level decoding network, scale-up on the M−n+1 feature maps subjected to fusion, respectively, to obtain the M−n+1 feature maps subjected to scale-up.

14. The method according to claim 11, wherein performing fusion on the M−n+1 feature maps subjected to scale-up to obtain the M−n+1 feature maps decoded at nth level comprises:
performing, by M−n+1 second fusion sub-networks of the nth decoding network, fusion on the M−n+1 feature maps subjected to scale-up to obtain M−n+1 feature maps subjected to fusion; and
performing, by a feature optimizing sub-network of the nth-level decoding network, optimization on the M−n+1 feature maps subjected to fusion, respectively, to obtain the M−n+1 feature maps decoded at nth level.

15. The method according to claim 12, wherein determining the prediction result of the image to be processed according to the target feature map decoded at Nth level comprises:
performing optimization on the target feature map decoded at Nth level to obtain a predicted density map of the image to be processed; and
determining the prediction result of the image to be processed according to the predicted density map.

16. The method according to claim 1, wherein performing, by the feature extraction network, feature extraction on the image to be processed, to obtain the first feature map of the image to be processed comprises:
performing, by at least one first convolution layer of the feature extraction network, convolution on the image to be processed to obtain a feature map subjected to convolution; and
performing, by at least one second convolution layer of the feature extraction network, optimization on the feature map subjected to convolution to obtain the first feature map of the image to be processed.

17. The method according to claim 16, wherein the first convolution layer has a convolution kernel size of 3×3 and a step length of 2; the second convolution layer has a convolution kernel size of 3×3 and a step length of 1.

18. The method according to claim 1, wherein the method further comprises:
training the feature extraction network, the M-level encoding network and the N-level decoding network according to a preset training set, the training set containing a plurality of sample images which have been labeled.

19. An image processing apparatus, comprising:
A processor; and
a memory configured to store processor-executable instructions,
wherein the processor is configured to invoke the instructions stored in the memory, so as to:
perform, by a feature extraction network, feature extraction on an image to be processed, to obtain a first feature map of the image to be processed;
perform, by an M-level encoding network, scale-down and multi-scale fusion processing on the first feature map to obtain a plurality of feature maps which are encoded, each of the plurality of feature maps having a different scale; and
perform, by an N-level decoding network, scale-up and multi-scale fusion processing on the plurality of feature maps which are encoded to obtain a prediction result of the image to be processed, M, N being integers greater than 1.

20. A non-transitory computer readable storage medium, having computer program instructions stored thereon, wherein when the computer program instructions are executed by a processor, the processor is caused to perform the operations of:
performing, by a feature extraction network, feature extraction on an image to be processed, to obtain a first feature map of the image to be processed;
performing, by an M-level encoding network, scale-down and multi-scale fusion processing on the first feature map to obtain a plurality of feature maps which are encoded, each of the plurality of feature maps having a different scale; and
performing, by an N-level decoding network, scale-up and multi-scale fusion processing on the plurality of feature maps which are encoded to obtain a prediction result of the image to be processed, M, N being integers greater than 1.
